(19) United States
(12) Patent Application Publication
(10) Pub. No.: US 2017/0058233 A1
(43) Pub. Date: Mar. 2, 2017

(54) METHOD FOR FRACTIONATION OF A PROTEIN AND LIPID CONTAINING MATERIAL

(71) Applicants: Hui Wang, Des Moines, IA (US); TONG WANG, AMES, IA (US)

(72) Inventors: Hui Wang, Des Moines, IA (US); TONG WANG, AMES, IA (US)

(21) Appl. No.: 15/242,576

(22) Filed: Aug. 21, 2016

Related U.S. Application Data
(60) Provisional application No. 62/208,916, filed on Aug. 24, 2015.

(51) Int. Cl. C11B 1/10

(52) U.S. Cl. CPC C11B 1/10

(57) ABSTRACT

The present invention relates to a method for fractionating a starting material containing a protein and lipids or phospholipid. The method comprises providing the starting material containing the protein and the lipids or phospholipid, extruding the starting material into first solvent having a temperature of 20-200° C. to form a solid phase of a texturized matrix enriched with the protein and not soluble in the first solvent and a lipids-enriched or phospholipid-enriched fluid phase, and collecting, separately, the solid phase of the texturized matrix enriched with the protein and the lipids-enriched or phospholipid-enriched fluid phase.

### CROSS REFERENCE TO RELATED APPLICATION

This non-provisional application claims the benefit of U.S. Provisional Application No. 62/208,916, filed Aug. 24, 2015.

### FIELD OF THE INVENTION

The present invention generally relate to protein and lipid fractionation. In particular, the present invention relates to methods for fractionating a protein and lipids-containing material into a separate solid phase of a texturized matrix enriched with the protein and a fluid phase enriched with lipids, such as lecithin.

### BACKGROUND OF THE INVENTION

Phospholipids are widely used as nutritional ingredients and effective emulsifier and lubricating agents in food, pharmaceutical, and cosmetic applications. Soy lecithin is the most commercial available phospholipid made by an acetone wash of the soybean oil “gums,” a by-product from the chemical degumming of a crude soybean oil (European Patent EP1272049 B1 to Rassenhovel et al.). The commercial supply of the egg lecithin is limited. However, the demands for the egg lecithin are high. This is because one third of the lipids in eggs are phospholipids (PL), much higher than a vegetable oil, such as soybean oil which has only 2-2.9% lipids being phospholipids (Huopalahti et al., Bioactive Egg Compounds (Springer-Verlag Berlin Heidelberg, Heidelberg, Germany, 2007); Galhardo et. al., Edible Oil Processing: Enzymatic Degumming (AOCS Lipid Library, online literature accessed August 2014: http://lipidlibrary.aocs.org/processing/degum-enz/index.htm)). Moreover, egg phospholipids contain polyunsaturated fatty acids such as arachidonic acid (AA) and docosahexaenoic acid (DHA) that are not found in soy lecithin (Ymamoboca et al., Hen Eggs: Their Basic and Applied Science (CRC Press LLC, Boca Raton, 1997)), a generic commercial term for soy phospholipid. AA and DHA are essential to the healthy development of brain, eyes, and hearts of preterm and term infants (Fleith, “Dietary PUFA for Preterm and Term Infants: Review of Clinical Studies,” Crit. Rev. Food Sci. Nutr. 45:205-29 (2005)). Compared to soybean phospholipid, egg phospholipid has about 3 times more of phosphatidylcholine (PC), which contains choline, a key nutrient for the health of human nerve system (Zeisel, “Choline: Critical Role during Fetal Development and Dietary Requirements in Adults,” Annu. Rev. Nutr. 26:229-250 (2006)). Due to its relatively higher saturated fatty acid profile (e.g., a high proportion of phosphatidylcholine), egg phospholipid is believed to be more oxidation stable than soy lecithin (Palacios, “Egg-Yolk Lipid Fractionation and Lecithin Characterization,” J. Am. Oil. Chem. Soc. 82:571-578 (2005)). Therefore, there is a need in the art to develop more efficient extraction methods that could reduce the overall cost and increase the supply of egg lecithin at a more affordable price for the end users.

The production of shell eggs in the U.S. reached 7.96 billion during June 2014. Of all the eggs produced in the U.S., typically about 32% are broken and, thus, are processed into a pasteurized liquid, frozen, and dry form of whole egg, or individual components like egg white and egg yolk (United State Department of Agriculture, Economics, Statistics and Market Information System, Chickens and Eggs (online material released Jul. 22, 2014, by the National Agricultural Statistics Service, Agricultural Statistics Board, United States Department of Agriculture, accessed August 2014: http://usda.mannlib.cornell.edu/usda/current/ChicEggs/ChicEggs-07-22-2014.pdf); American Egg Board (online material accessed June 2014: http://www.aeb.org/egg-industry/industry-facts/egg-industry-facts-sheet)). With a reliable large scale supply and a high oil level (60% of the dry yolk matter), shell egg can be considered a natural oil crop. Because of the ease of separation of yolk and white at commercial scales and because the egg lipids are exclusively contained in the yolk, egg lipids are typically extracted from egg yolks.

Two major egg yolk products are produced at a large scale: spray-dried egg yolk powder and pasteurized liquid egg yolk. Both have been used for lipid extractions. Most of the known extraction methods involve two or more organic solvents with different polarities, such as ethanol, propanol, hexane, acetone, and ether (Sim et al., Egg Uses and Processing Technologies (CAB International, Wallingford, U K, 1994)). Acetone has been a commonly used solvent to separate neutral lipids from phospholipids since phospholipids are insoluble in acetone. For instance, a spray-dried yolk powder was first washed by acetone to remove most of the neutral oil before phospholipids were extracted by the 96% ethanol (Nielson et al., “In Situ Solid Phase Extraction of Lipids from Spray-Dried Egg Yolk by Ethanol with Subsequent Removal of Triacylglycerols by Cold Temperature Crystallization,” LWT—Food Science and Technology 37:613-618 (2004); Nielson, “Production of Phospholipids from Spray-Dried Egg Yolk by Consecutive In Situ Solid Phase Extraction with Acetone and Ethanol,” LWT—Food Science and Technology 40:1337-1343H (2007)). In another study, ethanol was first used to extract the polar lipids from a liquid yolk, then hexane was used to extract the residual oil of less polarity. Multiple washes between the hexane extract and ethanol extract were employed to partition the polar lipids into phospholipid-enriched fraction and neutral lipids oil fraction. The ethanol extracts were combined and the phospholipid was finally purified by acetone precipitation to a purity of 95% (Palacios, “Egg-Yolk Lipid Fractionation and Lecithin Characterization,” J. Am. Oil. Chem. Soc. 82:571-578 (2005)). However, it was found that acetone can react with aminophospholipids chemically to form acetone abducts (Nielson, “Production of Phospholipids from Spray-Dried Egg Yolk by Consecutive In Situ Solid Phase Extraction with Acetone and Ethanol,” LWT—Food Science and Technology 40:1337-1343H (2007); Kuksis et al., “Covalent Binding of Acetone to Aminophospholipids in Vitro and in Vivo,” Ann. N. Y. Acad. Sci. 1043:417-39 (2005)). Those phospholipid-acetone derivatives give the phospholipid extract an unpleasant flavor or aftertaste (European Patent EP1272049 B1 to Rassenhovel et al.).

To avoid acetone, low temperature treatment was used as an alternative for the separation of neutral oil and phospholipid. At freezing temperatures, a majority of the neutral oil is crystallized due to their higher melting point while most of the phospholipids remain in the liquid phase. The crystallized neutral lipids can be removed by filtration or centrifugation. For example, the ethanol extract with a phospholipid purity of 73% was increased to 83% after removal of triacylglycerols by a cold-temperature crystallization at 0° C. (Nielson et al., “In Situ Solid Phase Extraction of Lipids from Spray-Dried Egg Yolk by Ethanol with Subsequent Removal of Triacylglycerols by Cold Temperature Crystallization.” LWT—Food Science and Technology 37:613-618 (2004)). A similar strategy was used by in Canadian Patent Document No. CA 1335054 C to Sim, in which the phospholipid was concentrated by crystallizing neutral lipids at the temperatures between 0-10° C. There, the purities of the neutral lipid and phospholipid fractions were 97% and 89%, respectively. However, no phospholipid yield was presented.

Supercritical fluid technology has been used for egg phospholipid extraction (Huopalahti et al., Bioactive Egg Compounds (Springer-Verlag Berlin Heidelberg, Heidelberg, Germany, 2007)). A study by Aro et al., “Isolation and Purification of Egg Yolk Phospholipids using Liquid Extraction and Pilot-Scale Supercritical Fluid Techniques,” Eur. Food Res. Technol. 228:857-863 (2009) exemplified its feasibility at a laboratory scale. The yolk lipids were extracted by supercritical CO₂ before the phospholipid was precipitated at a high purity on the wall of the pressurized chamber via a supercritical antisolvent process, using ethanol as the antisolvent. A phospholipid purity of 99% and a yield of 85-95% were reported. However, that extraction method can only be carried out in batch-wise operation, and it would be still years away from a wide commercial adoption due to the high equipment and operation costs.

When being mixed with a solvent during the lipid extraction, the liquid yolk and spray-dried yolk powder form a muddy mixture, making conventional solvent extraction impractical. Therefore, a prolonged time is needed to allow the different liquid layers to settle, and a vigorous filtration or centrifugation is often needed to separate the miscella from the yolk solids in the liquid system (European Patent EP1272049 B1 to Rassenhovel et al.). The buildup of fine solids and holdup of the solvent in the fine solids can dramatically compromise the efficiency of the extraction.

Drum-dried thin egg flakes were also found to be a suitable material for the yolk lipid extraction in Wang et al., “Extraction of Phospholipids from Structured Dry Egg Yolk,” J. Am. Oil Chem. Soc. 91:513-520 (2014). However, that method required the lipid yolk to be structured and dried first. Moreover, a common scheme for phospholipid fractionation using dried yolks employs an initial de-oiling step. The phospholipid is then extracted from the de-oiled material with ethanol. However, such extracted phospholipid fraction has a relatively low phospholipid purity, and the recovery of total phospholipid in this extract is also relatively low.

Therefore, there remains a need for an efficient process that can extract lipids directly from liquid egg yolk with a shorter processing time, better lipid quality, and instant fractionation of the polar components, without using a hazardous solvent. The present invention is directed to fulfilling this need in the art.

### SUMMARY OF THE INVENTION

One aspect of the present invention relates to a method for fractionating a starting material containing a protein and one or more types of lipids. The method comprises providing the starting material containing the protein and the lipids. The starting material is extruded into first solvent having a temperature of 20-200° C. to form a solid phase of a texturized matrix enriched with the protein and not soluble in the first solvent and a lipids-enriched fluid phase. The solid phase of the texturized matrix enriched with the protein and the lipids-enriched fluid phase are then separately collected.

Another aspect of the present invention relates to a method for extracting and enriching phospholipid from a starting material containing a protein and a phospholipid. The method comprises providing the starting material containing the protein and the phospholipid. The starting material is extruded into a first polar solvent having a temperature of 20-120° C. to form a solid phase of a texturized matrix enriched with the protein and not soluble in the first polar solvent and a phospholipid-enriched fluid phase. The solid phase of the texturized matrix enriched with the protein and the phospholipid-enriched fluid phase are then separately collected.

In the present invention, a novel method for simultaneous texturization of liquid yolk and extraction of lipid is presented. The liquid yolk is “texturized” in a suitable condition (e.g., liquid yolk is extruded into a hot alcohol bath) to form a protein-protein network, which helps maintain the physical structure of the yolk matrix without forming loose particles during solvent extraction. During this texturization process, the lipid extraction, the water removal from the yolk, and the coagulation of yolk protein into a texturized form all occur simultaneously. See a flow chart showing a process for simultaneous texturization and lipid extraction of liquid yolk in FIG. 1. The texturization of the yolk protein and lipids extraction occurs in one step, which improves the lipid extraction efficiency as well as producing a texturized and defatted yolk protein at the same time. The benefits of this method include a shorter processing time, better lipid quality, and instant fractionation of the polar components.

As an example, a simultaneous texturization and extraction of phospholipids (STEP) technique is developed to process liquid egg yolk. As described in Examples 1-4, three solvents-100% butanol, 80% butanol, and 95% ethanol—were used. All the solvents can texturize the liquid yolk and at the same time recover the lipids. The 100% and 80% butanol solvents appear to be more effective than the 95% ethanol in extracting total yolk lipids but have less of a preference for phospholipids than the 95% ethanol. The 95% ethanol shows preference on extraction of phospholipids to neutral lipids. Using the STEP method with the 95% ethanol, phospholipids can be enriched to 80% directly from the liquid yolk with a phospholipid yield of 78%.

### BRIEF DESCRIPTION OF THE DRAWINGS

FIG. 1 is a flow chart showing a process for simultaneous texturization and lipid extraction of liquid yolk.

FIG. 2 is a flow chart showing a process of separating phospholipids from extracted yolk lipids.

FIG. 3 is a schematic drawing of a solvent extraction system used for obtaining total lipids from a yolk.

FIG. 4 is a graph showing the lipid extraction yield by the liquid yolk simultaneous texturization and phospholipid extraction, as compared to the yolk lipids extracted from a liquid yolk by chloroform:methanol as the control and base. BU: 100% 1-butanol. ETW: 95% (v/v) aqueous ethanol. BUW: water-saturated 1-butanol (about 80%, w/w). Error bars represent standard deviations.

FIG. 5 is a graph showing the total lipid yield by the liquid yolk simultaneous texturization and phospholipid extraction, as compared to the yolk lipids extracted from a liquid yolk by chloroform:methanol as the control and base. BU: 100% 1-butanol. ETW: 95% (v/v) aqueous ethanol. BUW: water-saturated 1-butanol (about 80%, w/w). Error bars represent standard deviations.

FIG. 6 is a graph showing the phospholipid extraction yield by the liquid yolk simultaneous texturization and phospholipid extraction, as compared to the yolk lipids extracted from a liquid yolk by chloroform:methanol as the control and base. BU: 100% 1-butanol. ETW: 95% (v/v) aqueous ethanol. BUW: water-saturated 1-butanol (about 80%, w/w). Error bars represent standard deviations.

FIG. 7 is a graph showing the total phospholipid yield by the liquid yolk simultaneous texturization and phospholipid extraction, as compared to the yolk lipids extracted from a liquid yolk by chloroform:methanol as the control and base. BU: 100% 1-butanol. ETW: 95% (v/v) aqueous ethanol. BUW: water-saturated 1-butanol (about 80%, w/w). Error bars represent standard deviations.

FIG. 8 is a graph showing the phospholipid content in the lipid fractions extracted by the liquid yolk simultaneous texturization and phospholipid extraction, as compared to the yolk lipids extracted from a liquid yolk by chloroform:methanol as the control and base. BU: 100% 1-butanol. ETW: 95% (v/v) aqueous ethanol. BUW: water-saturated 1-butanol (about 80%, w/w). Error bars represent standard deviations.

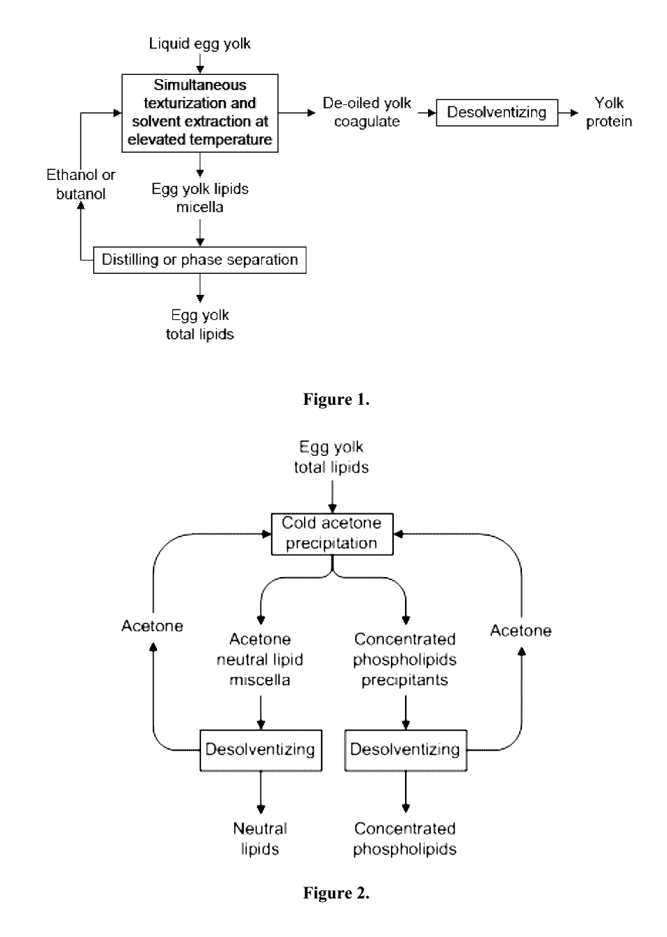

### DETAILED DESCRIPTION OF THE INVENTION

One aspect of the present invention relates to a method for fractionating a starting material containing a protein and one or more lipids. The method comprises providing the starting material containing the protein and the lipids. The starting material is extruded into first solvent having a temperature of 20-200° C. to form a solid phase of a texturized matrix enriched with the protein and not soluble in the first solvent and a lipids-enriched fluid phase. The solid phase of the texturized matrix enriched with the protein and the lipids-enriched fluid phase are then separately collected.

The starting material used in accordance with this method contains a protein and one or more types of lipids. Suitable starting materials include, but are not limited to, egg; egg yolk; fish roe; animal brain tissue; animal blood; diary product, such as diary paste, milk or condensed milk, and cream; microbes; microalgae; oilseed, and mixtures thereof. The starting material can be obtained from a natural biomaterial. The starting material is typically in a raw material form without further processing, although further processing, purification, or enrichment of certain ingredients from a raw material before being used as the starting material is also envisioned. As used herein, the terms egg, egg yolk, fish roe, animal brain tissue, animal blood, diary product, microbes, microalgae, and oilseed include genetically modified versions thereof. An exemplary starting material is egg yolk. For instance, liquid egg yolk in its raw material form is used as the starting material.

The lipids may also be referred to as “total lipids” herein as they include non-polar neutral lipids and polar lipids such as lecithin (or phospholipid). For instance, egg yolk total lipids typically contain water, 67% non-polar neutral lipids or oils (e.g., triglycerides and cholesterol), and 33% of polar phospholipid on dry matter basis.

“Lecithin” can be used for its broadest meaning, e.g., a generic term to designate any group of yellow-brownish fatty substances occurring in animal and plant tissues comprising primarily polar lipids, such as phospholipids and glycolipids, and other components, such as accompanying free fatty acids, neutral glycerol fatty acid esters (e.g., triglycerides), and natural pigments such as carotenoids. When lecithin is used in connection with soy or egg yolk, it covers essentially phospholipids, and the term “lecithin” can be used interchangeably with the term “phospholipid.”

The starting material is extruded into a first solvent to form a solid phase of a protein-enriched texturized matrix and a lipids-enriched fluid phase. The extruding step can be carried out by any machine or device that can conduct a high shear process. For instance, the extruding step can be carried out by an injection or spinning (e.g., centrifugal spinning or electronic spinning) equipment. The instrument for extrusion is set up such that the extruded starting material can form a texturized matrix in a thread, strip, or sheet form in the solvent. The dimensions of the extruded starting material depend on the instrument for extrusion that is selected, and can vary in a wide range. For instance, the diameter of the extruded thread may be less than 5 mm, or range from 0 to 3 mm, from 1 to 3 mm, or from 2 to 3 mm. The thickness of the strip or sheet of the extruded starting material may be less than 5 mm, or ranges from 0 to 3 mm, from 1 to 3 mm, or from 2 to 3 mm. Typically, the thinner the extruded material, the easier to form texturized matrix.

The formation of the solid phase of the protein-enriched texturized matrix, during the extruding and extracting step, may be aided by additional technologies that provide external disruption of the protein structures. With the aid of these additional technologies during the extruding step, a liquid egg yolk can be extruded to form a solid phase of protein-enriched texturized matrix even when the solvent is water in ambient temperature or an alcohol (such as ethanol) in relatively low concentration. Suitable technologies that may be provided during the extruding step include, but are not limited to, treatments involving sound energy (such as sonication), electromagnetic radiation (such as microwave radiation and infrared radiation).

In a conventional solvent extraction process, a major problem associated with yolk oil extraction from egg yolk is the formation of a thick and muddy mixture. Extraction methods using an alcohol include harsh extraction and mild extraction. A harsh extraction method uses high alcohol concentrations and/or high extraction temperatures, under which conditions the yolk protein is denatured. For example, as shown in Canadian Patent Document No. CA 1335054 to Sim, which is hereby incorporated by reference in its entirety, after the liquid yolk was mixed with 90-98% ethanol at 45-75° C., the protein was denatured and filtered out, and the phospholipid was further concentrated by a chilling treatment to remove the neutral lipids. In U.S. Pat. No. 7,566,570 B2 to Abril, which is hereby incorporated by reference in its entirety, the liquid yolk was blended with 85% isopropanol and water (with a liquid yolk, isopropanol, and water ratio of 100:60:35) at 60° C. After cooling to ambient temperature, the mixture was centrifuged to produce an intermediate phase with a phospholipid purity of 70%. No overall phospholipid yields were available from either Sim or Abril. A mild extraction method, on the other hand, uses an alcohol concentration and treatment temperature low enough so that the yolk protein remains undenatured. This technique was disclosed in Canadian Patent Document No. CA 2398053, which is hereby incorporated by reference in its entirety, in which an aqueous alcohol with a concentration below 35% was mixed with the liquid yolk and the extraction temperature was maintained below 65° C. There, the treatment conditions were provided to avoid the denaturation of the yolk protein and the degradation of the phospholipids.

However, when using a conventional solvent extract process, it is difficult to achieve a good separation between the solvent and the yolk solids. The solid fraction also usually retains a large volume of solvent which is solubilized with lipids and, thus, reducing the lipid recovery. It was considered hardly possible to effectively extract egg lipids from the raw yolk by the use of a single solvent, because a raw yolk in the natural state is present in the form of a stable emulsion (see, e.g., U.S. Pat. No. 4,157,404, which is hereby incorporated by reference in its entirety). For example, polar solvents such as methanol and acetone are capable of destroying the emulsion of raw yolk to extract and remove water; however, these polar solvents have poor ability to extract egg lipids. Non-polar solvents, such as ethyl ether, hexane, and trichloroethylene, are hydrophobic and typically could not extract and remove water from a raw yolk. These non-polar solvents were not only unable to destroy the emulsion of raw yolk sufficiently, they actually cooperated with the raw yolk to form a one-phase emulsion. Therefore, the use of a single solvent in a conventional solvent extraction process typically cannot effectively obtain egg lipids from the raw yolk. Moreover, conveying the muddy mixture from one step to another without fouling the equipment is an engineering challenge.

The present invention, on the other hand, uses a simultaneous texturization of a protein-enriched matrix and extraction of lipids to overcome these problems faced in a conventional solvent extraction process. By the extruding step, the starting material is continuously and gradually extruded into a solvent to form a texturized protein-enriched matrix. The texturization process causes the proteins to form an interlocked network so that the protein particles are held together during solvent extraction. The protein-enriched matrix is typically thin and/or porous enough to allow solvent penetration and extraction of the total lipids. The separation of this uniformly texturized protein-enriched matrix and lipid miscella is, therefore, much easier than the solvent-liquid yolk slurry produced in the conventional methods.

The process of simultaneous texturization of a protein-enriched matrix and extraction of lipids is dynamic. Once the starting material touches the solvent, the protein in the starting material is denatured and likely forms a spongy structure in a short period of time. On the other hand, the mass transfer between the texturized matrix and the bulk of the solvent can be continuous and may take a long time until an equilibrium is reached or a component is depleted. Such mass migrations are along the concentration gradients for each component: water and lipids diffuse from the protein-enriched matrix to the bulk solvent phase, whereas the organic solvent molecules diffuse in the opposite direction. The solvent may have destroyed the structure of the native lipid liposome and lipoproteins, or have broken the affinity between the lipid and its associated proteins. The texturization process, thus, forms a protein-protein network which helps maintain the physical structure of the protein-enriched matrix without forming loose particles during solvent extraction. During this texturization process, the lipid extraction, the water removal from the protein-enriched matrix, and the coagulation of protein into a texturized form all occur simultaneously.

The first solvent used in the extruding step can be in a liquid form or in gaseous form. The first solvent can be any solvent suitable for solvent extraction of lipids from protein-lipid complex known to one skilled in the art. Suitable first solvents include water, alcohols, hexane, other polar and non-polar solvents, or combinations thereof. Hot water or steam can be used as a solvent for texturization. An alcohol suitable for such use can contain 1-4 carbon atoms or combinations thereof. Suitable alcohols include ethanol, propanol, isopropanol, n-propanol, n-butanol, sec-butanol, isobutanol, and tert-butanol. The first solvent can be in a pure form or as an aqueous solution having a concentration from 1% to 100%, for instance, from 50% to 100%, from 60% to 100%, from 60% to 100%, from 60% to 100%, from 70% to 100%, from 75% to 100%, from 80% to 100%, from 85% to 100%, from 90% to 100%, or from 95% to 100%. When selecting the solvent used in the method of the present invention, “green” solvents (i.e., solvents that can be made through a natural process (e.g., ethanol and n-butanol can be produced by fermentation)) are usually desirable. Polar solvents are typically desirable as they can penetrate the matrix of the hydrated protein-enriched matrix to leach out the lipids. Also, solvents that can denature proteins at room temperature or elevated temperature are desirable as they induce the “texturization” of the proteins in the starting material. A typical solvent used in the method is ethanol or n-butanol.

The method can be carried out with a single solvent. An exemplary single solvent used in the method is ethanol or n-butanol.

In carrying out the present invention, the first solvent can be used at widely ranging temperatures as long as the texturization can occur when the starting material is extruded into the first solvent. The first solvent can have a temperature from 20° C. to 200° C., for instance, from 25° C. to 120° C., from 50° C. to 100° C., from 50° C. to 95° C., from 70° C. to 80° C., or from 75° C. to 80° C. The temperature range of the first solvent depends on the type of solvent used and is also correlated to the extrusion process. For instance, when polar solvents such as ethanol or n-butanol are used, the solvent will have a wider temperature range for inducing the “texturization” of the proteins in the starting material. When non-polar solvents such as hexane are used, a higher temperature (e.g., higher than about 70° C.) would be desirable to induce the “texturization” of the proteins in the starting material.

The amount of first solvent used can vary greatly. Typically, the first solvent to the starting material weight ratio ranges from 1:1 to 10:1, from 1:1 to 3:1, or from 2:1 to 3:1.

After the extruding step, the starting material containing a protein and one or more types of lipids is texturized into a protein-enriched matrix, and, because the texturized matrix is not soluble in the first solvent whereas the other components in the starting material (such as lecithin or other lipids or oils) are, the starting material is well-separated into two phases: a solid phase of a texturized matrix enriched with the protein and a fluid phase enriched with neutral and polar lipids.

The resulting solid phase of the protein-enriched texturized matrix can be collected by any suitable separation techniques known to one skilled in the art, such as gravity precipitation, filtration, pressing (e.g., mechanical pressing, hydraulic pressing, screw pressing, or rotary pressing), centrifugation, or combinations thereof. The solid phase and the fluid phase may be so well separated that collecting the solid phase of the protein-enriched texturized matrix can be carried out by gravity precipitation, without the aid of additional separate techniques.

To improve the separation between the protein and lipids, and to improve the recovery of lipids, the collected solid phase of the protein-enriched texturized matrix can be contacted with additional first solvent to extract residual lipids in the solid phase of the protein-enriched texturized matrix. This step can be carried out multiple times for a more complete extraction. To improve the efficiency of the extraction of lipids with a limited amount of solvent, the extruding or extracting step can be carried out in a batch or continuous counter current fashion.

When multiple steps of extraction are conducted, the resulting fluid phases from each can be combined so that the lipids in the fluid phase can be further processed together.

When extrusion is carried out at a temperature higher than ambient temperature and when the first solvent used is an alcohol, the fluid phase enriched with lipids can be allowed to cool to ambient temperature, so that the total lipids will naturally separate from the solvent due to the unique oil solubility properties of the alcohols.

The collected solid phase of the protein-enriched texturized matrix can be dried by any suitable drying techniques known to one skilled in the art to obtain a substantially or fully de-oiled protein. For instance, the texturized protein may be dried by heating (e.g., at a temperature ranging from 20-40° C.) in a vacuum oven. Thus, through this process, a valuable product can be produced—i.e., a de-oiled protein (e.g., de-oiled egg yolk protein) which may be used to prepare low-fat and high protein food products.

The collected lipids-enriched fluid phase can be dried by any suitable drying techniques known to one skilled in the art to obtain the lipids. The first solvent that solubilizes lipids can be separated from the collected fluid phase during drying (e.g., by a rotary vacuum evaporator) under relatively mild conditions. The separated, de-oiled first solvent can be recycled to the extruding step during a continuous process. For that matter, the extrusion and solvent extraction system can be configured to be a continuous flow system (e.g., a continuous counter current fashion) so that the separated first solvent can be recycled back to the system for continuous extrusion and extraction. This reduces the cost for solvents.

Depending on the type of the first solvent used in the extraction system, the lipids-enriched fluid phase may contain polar lipids as well as non-polar lipids or oils. For instance, when the starting material is egg yolk, subjecting the liquid egg yolk to the extruding step forms a separated solid phase of de-oiled egg yolk protein and a fluid phase of egg yolk lipids. These lipids are a complex mixture of neutral lipids or egg oils (e.g., triglycerides) and polar lipids containing egg lecithin (e.g., phospholipids which contain a high level of phosphatidylcholine), together with cholesterol.

This lipids-enriched fluid phase may be further separated into a neutral lipid fraction and a polar lipid fraction. For example, the collected lipids-enriched fluid phase can be subjected to a cold temperature crystallization to separate the lipids-enriched fluid phase into a neutral lipid-enriched phase and a phospholipid-enriched fluid phase, and the neutral lipid-enriched phase and the phospholipid-enriched fluid phase can be collected separately. The cold temperature crystallization process crystallizes and precipitates the neutral lipids or oils out from the solution, providing a residual solution containing phospholipids. This cold temperature crystallization, however, can be an expensive process and does not achieve a high efficiency of separation.

In another example, the collected lipids-enriched fluid phase can be dried to remove the first solvent and mixed with a second solvent to separate the lipids-enriched fluid phase into a neutral lipid-enriched phase and a phospholipid-enriched phase. This lipid fractionation is based on the solubility difference between the neutral lipids and phospholipids in the second solvent. An exemplary second solvent is acetone (see the process carried out in acetone, as shown in FIG. 2). The neutral lipids or oils (e.g., triacylglycerols) are soluble in acetone but the phospholipids are not. The phospholipid can be precipitated out and separated from the acetone solution, providing a residual solution containing the neutral lipids or oils.

After the separation, the neutral lipids or oils and the phospholipids can then be collected separately, and dried by any suitable drying techniques known to one skilled in the art (see the process as shown in FIG. 2). The solvent can be removed, e.g., by a rotary vacuum evaporator under relatively mild conditions. The final product can be further dried by heating (e.g., at a temperature ranging from 20 to 70° C., or from 20 to 40° C.) in a vacuum oven under relatively mild condition. It is undesirable to heat the lipids or phospholipids over 70° C. as heating above this temperature may lead to thermal degradation of the phospholipids. Thus, through this process, two valuable co-products can be produced: neutral lipids (e.g., egg oil) and phospholipids (e.g., egg lecithin). The egg lecithin obtained through the process of the present invention has a high purity level with a high level of phosphatidylcholine, and is essentially free from, or contains only very minor amounts of, cholesterol.

When the first solvent used is a polar solvent, such as an alcohol containing 2-3 carbon atoms (e.g., ethanol, propanol, isopropanol, and n-propanol), the lipids collected in the lipids-enriched fluid phase can be primarily lecithin (i.e., phospholipid), without further separation and extraction.

Accordingly, another aspect of the present invention relates to a method for extracting and enriching phospholipid from a starting material containing a protein and a phospholipid. The method comprises providing the starting material containing the protein and the phospholipid. The starting material is extruded into a first polar solvent having a temperature of 20-120° C. to form a solid phase of a texturized matrix enriched with the protein and not soluble in the first polar solvent and a phospholipid-enriched fluid phase. The solid phase of the texturized matrix enriched with the protein and the phospholipid-enriched fluid phase are then separately collected.

In this aspect of the present invention, by the unique extruding process and the use of polar solvent, phospholipids can be enriched from the starting material in a one-step process using only a single solvent, and without using acetone, cold temperature crystallization, or other lipid separation techniques. As demonstrated in Examples 1-4, the use of the 95% ethanol in the process can enrich the phospholipid from liquid egg yolk in a one-step process. For example, the first step of the simultaneous texturization and extraction of phospholipid (without further washing with additional solvents) can recover over 75% of the total phospholipids in the original liquid egg yolk into a separated lipid fraction, with the purity of phospholipid in the separated lipid fraction being about 80%.

The starting material used described above in the first aspect of the present invention can be used to carry out this aspect of the present invention.

The starting material is extruded into a first polar solvent to form a solid phase of a protein-enriched texturized matrix and a phospholipid-enriched fluid phase. The extruding step can be carried out in the same way as described above in the first aspect of the present invention.

The additional technologies, described above in the first aspect of the present invention that provide external disruptions of the protein structures to aid the formation of the solid phase of the protein-enriched texturized matrix during the extruding step, can be used in the same way in this aspect of the present invention.

The first polar solvent used in the extruding step can be in a liquid form or in gaseous form. Suitable first polar solvents are polar alcohols or combinations thereof. An alcohol suitable for such use can contain 2-3 carbon atoms or combinations thereof. Suitable alcohols include ethanol, propanol, isopropanol, and n-propanol. These alcohols are effective solvents for direct phospholipid extraction from the starting material in a one-step process, due to their polarity and miscibility with water. The first polar solvent can be in a pure form or as an aqueous solution having a concentration from 1% to 100%, for instance, from 50% to 100%, from 60% to 100%, from 60% to 100%, from 60% to 100%, from 70% to 100%, from 75% to 100%, from 80% to 100%, from 85% to 100%, from 90% to 100%, or from 95% to 100%. The selection criteria for the solvent discussed above in the first aspect of the present invention also applies to this aspect of the present invention. A typical solvent used in the method is ethanol.

The method can be carried out with a single solvent, such as ethanol.

In carrying out the present invention, the first polar solvent can be used at widely ranging temperatures as long as the texturization can occur when the starting material is extruded into the first polar solvent. The first polar solvent can have a temperature from 20° C. to 120° C., for instance, from 25° C. to 120° C., from 25° C. to 100° C., from 50° C. to 100° C., from 50° C. to 95° C., from 70° C. to 80° C., or from 75° C. to 78° C.

The amount of first polar solvent used can vary greatly. Typically, the first polar solvent to the starting material weight ratio ranges from 1:1 to 10:1, from 1:1 to 3:1, or from 2:1 to 3:1.

After the extruding step, the starting material is well-separated into two phases: a solid phase of a texturized matrix enriched with the protein and a fluid phase enriched with phospholipids. With this single-step process, the phospholipid-enriched fluid phase can contain phospholipid of at least about 70%, at least about 80%, or at least about 90%.

The resulting solid phase of the protein-enriched texturized matrix can be collected by the same way as described above in the first aspect of the present invention.

Similar to the first aspect of the present invention, the collected solid phase of the protein-enriched texturized matrix can be contacted with additional first polar solvent for one or more times to extract residual phospholipid in the solid phase of the protein-enriched texturized matrix. The extruding step can be carried out in a batch or continuous counter current fashion to improve efficiency of the extraction of lecithin or other lipids with a limited amount of solvent. Also, similar to the first aspect of the present invention, the fluid phase enriched with phospholipids can be allowed to cool to ambient temperature, so that the phospholipids will naturally separate from the solvent.

The collected solid phase of the protein-enriched texturized matrix can be dried by the same techniques as discussed above in the first aspect of the present invention. The collected phospholipid-enriched fluid phase can be dried by the same techniques as the techniques for drying the lipids-enriched fluid phase, as described above in the first aspect of the present invention. The first polar solvent can be recycled to the extruding step using the same mechanism and same extrusion and solvent extraction system as described above in the first aspect of the present invention.

To improve the purity of the collected phospholipids, the phospholipid-enriched fluid phase may be further processed to remove neutral lipids or oils that may be contained in the phospholipid-enriched fluid phase. The techniques to separate the neutral lipids or oils from the phospholipid are the same as those described above in the first aspect of the present invention. The resulting phospholipids can then be collected and dried by the same techniques used to collect and dry phospholipids, as described above in the first aspect of the present invention.

The present invention may be further illustrated by reference to the following examples.

### EXAMPLES

The following examples are for illustrative purposes only and are not intended to limit, in any way, the scope of the present invention.

### Example 1

### Experimental Materials

Refrigerated pasteurized liquid egg yolk was acquired from a commercial egg producer. Reagent-grade solvents and other chemicals were obtained from Fisher Scientific (Fair Lawn, N.J.).

### Example 2

### Simultaneous Texturization and Extraction of Phospholipid (STEP) Based on Liquid Yolk

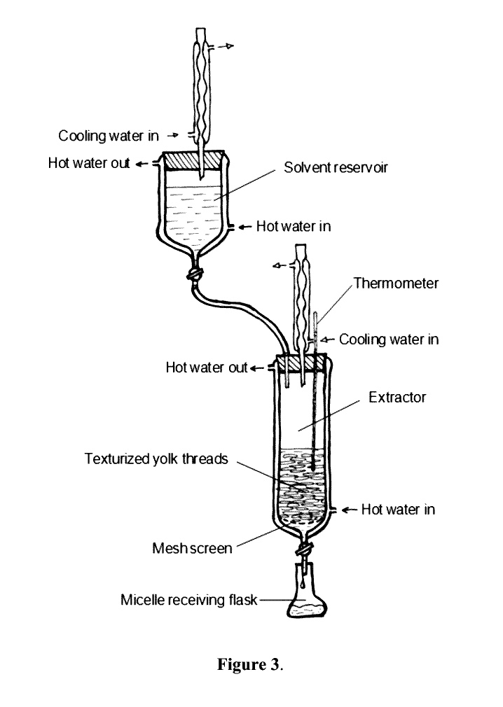

A laboratory solvent extraction system as shown in FIG. 3 was designed for the simultaneous texturization and extraction of phospholipid (STEP) from the yolk lipid. The system had a glass extraction cylinder at the bottom and a solvent reservoir on the top, both of which had water jacketed to maintain a temperature of 75° C. The glass extraction cylinder has a dimension of 48 mm×300 mm (i.e., inner diameter×height).

The STEP was achieved by injecting the liquid yolk in a form of thin stream into the hot solvent. Three solvents were used in this experiment: 95% (v/v) aqueous ethanol, water-saturated 1-butanol (about 80% butanol, w/w), and 100% 1-butanol. Upon contacting the solvent, the liquid yolk solidified into thread and the lipids were simultaneously extracted. The liquid egg yolk was metered using a peristaltic pump at a speed of 0.22 g/sec through a custom-designed “spin head”, which was modified from a syringe needle with an inner diameter of 0.603 mm. The needle was cross cut to remove the bevel tip. This spin head was mounted at the end of silicone tubing. To maintain the thin diameter of the texturized yolk, the spin head was manually rotated in a circular motion (about 150 rpm) right above the surface of the solvent. About 100 g of liquid yolk was spun and texturized in 200 ml of solvent. The texturized yolk looked like “angel hair pasta” with a diameter of 1 mm or less.

After the 100 g of liquid yolk was spun, the texturized yolk was soaked in the solvent for 6 minutes before the bottom valve was opened to drain the miscella fraction (i.e., the lipid-solvent mixture) under gravity for 3 minutes. This STEP extraction was labeled as Wash No. 1. The partially de-oiled yolk thread was then extracted four more times sequentially under the same conditions except that in each additional extraction only 100 ml of solvent was used. These additional extractions were labeled as Washes Nos. 2 to 4, respectively. After the first STEP extraction, the subsequent four washes can be considered as an in situ semi-continuous counter-current process. A total of five streams of miscella fractions were produced from the five extractions. The solvent in each miscella fraction was removed by a laboratory rotary evaporator under vacuum and the lipids were further dried at about 40° C. for about 5 hours in a vacuum oven. The control treatment was a total lipid extraction of drum-dried yolk flakes by using chloroform:methanol (2:1, v/v) as the solvent (Folch et al., “A Simple Method for the Isolation and Purification of Total Lipids from Animal Tissues,” J. Biol. Chem. 226:497-509 (1957), which is hereby incorporated by reference in its entirety). All extractions were carried out in duplicate.

### Example 3

### Phospholipid Quantification

The content of phospholipid (PL) and its individual components in all lipid samples was determined by ³¹P NMR (Yao et al., ³¹P NMR Phospholipid Profiling of Soybean Emulsion Recovered from Aqueous Extraction,” J. Agric. Food Chem. 58: 4866-4872 (2010), which is hereby incorporated by reference in its entirety).

Egg lipids (˜0.2 g) dissolved in 12 mL of chloroform/methanol (2:1, v/v) were washed with 3 mL of K-EDTA (0.1 M, pH 7.0). The chloroform phase was collected and mixed with 0.5 g of sodium sulfate to remove the residual water. The chloroform solution was filtered through a PTFE filter disk (0.45 μm), and the solvent was evaporated under a stream of nitrogen at 45° C. and vacuum oven-dried at 23° C. overnight. 90-100 mg of resulting egg lipid was then dissolved in 1 mL of chloroform-d and 1 mL of methanol in the presence of 8-10 mg of triphenyl phosphate as an internal standard. 1 ml of Cs-EDTA (0.2 M, pH 8.5) was then added. The mixture was shaken vigorously and then centrifuged at 1,800 g for 2 minutes (IEC Centra CL3, Thermo Fisher Scientific Inc., MA).

The lower phase was analyzed using ³¹P NMR. The NMR spectra were obtained with a Varian VXR-400 spectrometer (Varian, Inc., Palo Alto, Calif.) having a Bruker Magnet (Bruker BioSpin, Billerica, Mass.) operating at 162 MHz. Samples were analyzed with an inverse-gated decoupling pulse sequence. The NMR spectroscopic scan conditions were as follows: probe temperature, 29° C.; pulse width, 22 μs; sweep width, 9718 Hz; acquisition time, 1.2 s; relaxation delay, 10 s; and number of scans, 256. The relative composition percentage was expressed in molar percentage relative to the sum of all phospholipids that were detected by ³¹P NMR. The data processing was completed using MNova software (Mestrelab Research, Escondido, Calif.). The chemical shifts of phospholipid classes were determined by comparison with standards obtained from Avanti Polar Lipids, Inc. (Alabaster, Ala.).

### Example 4

### Statistical Analysis

All treatments were randomized with two replicates. The GLM procedure of the Statistical Analysis System (SAS) 9.1 (SAS institute, Cary, N.C.) was used for data analysis (SAS/STAT User's Guide®, Version 6 (Statistical Analysis System Institute Inc., Cary, N.C., 4^{th} ed. 1990)).

### Discussion of Examples 1-4

Liquid egg yolk texturized well in all the three solvents. The structured yolk did not collapse and no fine solids were found in the product. The miscella drained well under gravity.

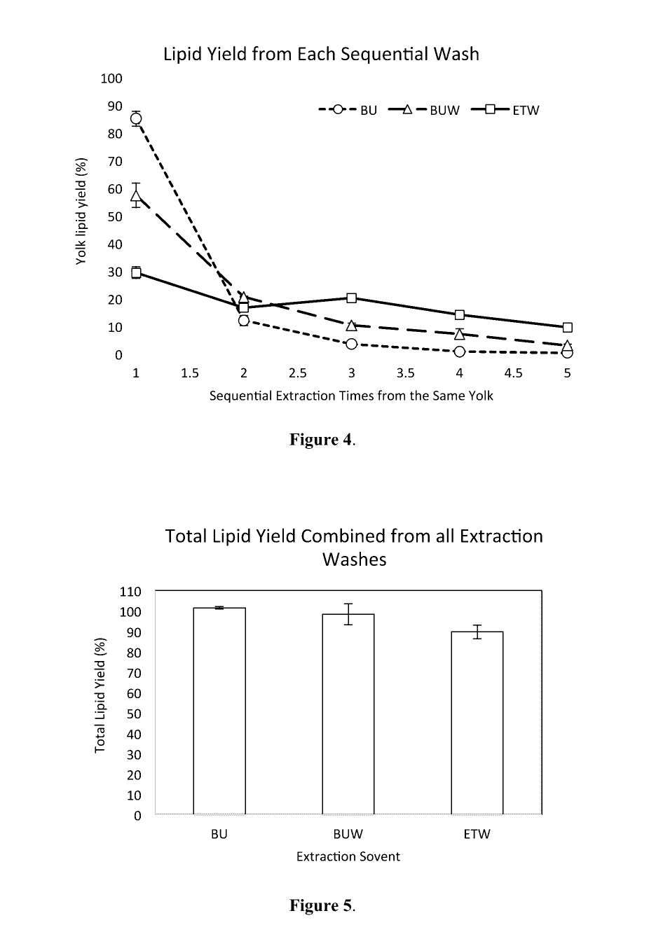

FIG. 4 compares the yolk lipid yields from the STEP (Wash No. 1) and its four sequential washes in the three different solvent systems. A steeper curve indicates that the yolk lipids were leached out faster. Pure butanol had the fastest extraction speed, followed by the 80% butanol. The 95% ethanol had the lowest extraction speed. The total lipid yields combining the five washes for each solvent system are presented in FIG. 5. As shown in FIG. 5, both pure butanol and the 80% butanol extracted all the lipids from the original yolk, while the 95% ethanol extracted 90% of the total lipids. It is possible that the 95% ethanol could recover the residual 10% of the total lipids if there were more washes are applied (FIG. 4).

The difference in the performance of different solvents, as shown in FIG. 4, may be explained by the polarity of the individual components in both the solvent systems and the liquid yolk. The polarity index values for water, ethanol, and butanol are 9.0, 5.2, and 4.2, respectively (Paul, The HPLC Solvent Guide (Wiley, New York, N.Y., 2^{nd} ed. 2002), which is hereby incorporated by reference in its entirety). The polarity of the three solvents in the STEP process is in the order (from low to high): pure butanol, the 80% butanol, and the 95% ethanol. Egg yolk lipids are known to contain water, 67% highly non-polar neutral lipids and cholesterol, and 33% of bipolar phospholipid on dry matter basis (Huopalahti et al., Bioactive Egg Compounds (Springer-Verlag Berlin Heidelberg, Heidelberg, Germany, 2007), which is hereby incorporated by reference in its entirety). The yolk lipid as a whole is expected to have a very low polarity. That explains why the 100% butanol extracts total lipids faster than the 80% butanol, and why the 95% ethanol extraction was the slowest. The same reasoning applies to the trend with the extraction yield of the total yolk lipid. For example, as shown in FIG. 4, for the STEP (Wash No. 1), the 100% butanol extracted about 85% of the total yolk lipid, while the 95% had the lowest yield among the three; it extracted only less than 30% of the total yolk lipid. The dewatering capacity of the solvents may have also played some role in the lipid extraction, but it does not appear as significant as the polarity of the solvents.

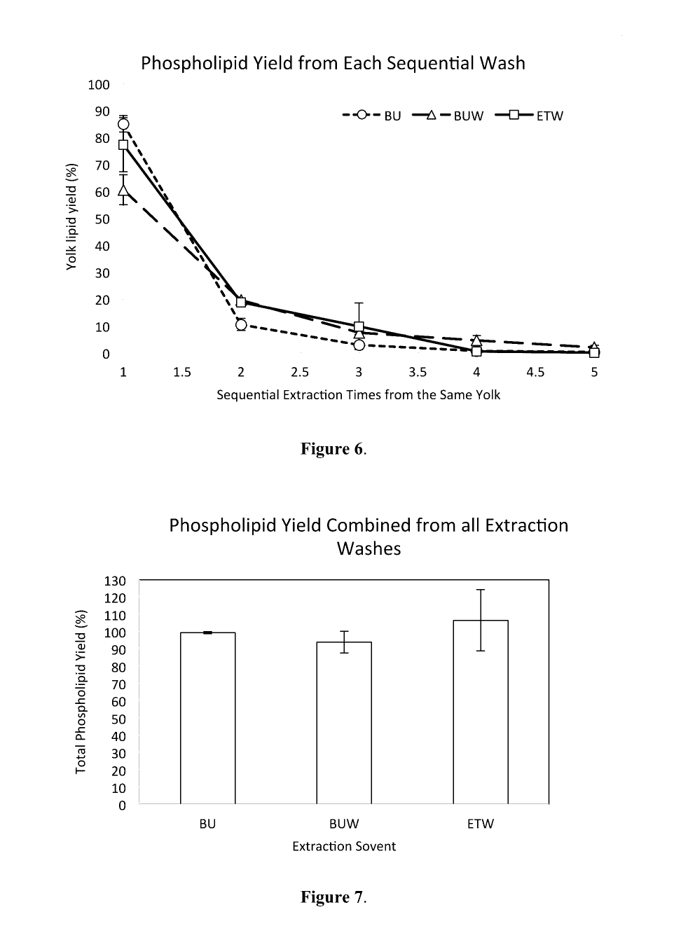

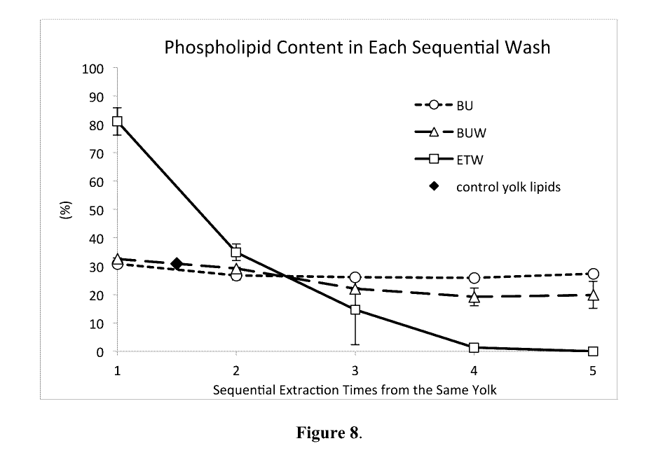

For the two butanol solvents, the phospholipid extraction speeds paralleled that of the total lipids, but the phospholipid extraction speed of the 95% ethanol was much higher than the total lipids extraction speed of the 95% ethanol, when comparing FIG. 6 and FIG. 4. For example, the 95% ethanol extracted about 78% of the total phospholipids in the yolk in the STEP (Wash No. 1) alone. This implies that the 95% ethanol had a higher extraction preference for the phospholipid than for neutral lipids in the liquid yolk. When five washes were combined, the 95% ethanol extracted about 90% of the total lipids (FIG. 5) and nearly 100% of the phospholipid (FIG. 7). FIG. 8 shows that the lipid fraction extracted by the 95% ethanol had a phospholipid purity of 80%. The phospholipid content in the extracts dwindled with additional sequential washes, most likely due to the depletion of the phospholipids. On the other hand, the 100% butanol extracted the phospholipids and neutral lipids almost at the natural ratio (about 30% phospholipid) in the original yolk in all the extraction washes. This indicates that the 100% butanol's preference for the phospholipids and neutral lipids coincided with the composition of the yolk lipids. Aqueous butanol (80%) showed a trend similar to the 100% butanol.

These results demonstrate that the 95% ethanol's extraction preference can be used to enrich the phospholipid from liquid yolk in a one-step process. For example, the first step of the STEP extraction (Wash No. 1) can recover over 75% of the total phospholipid in the original liquid yolk into a lipid fraction of phospholipid with a purity about 80%. The partially de-oiled yolk can be used to extract the residual phospholipid-lean yolk lipids.

The STEP extraction is a dynamic process. Once the yolk protein touched the solvent, the protein was denatured and likely formed a spongy structure in a very short period of time. On the other hand, the mass transfers between the texturized yolk and the bulk of the solvent is expected to be continuous and take a long time until an equilibrium is reached or a component is depleted. Such mass migrations are along the concentration gradients for each component: water and yolk lipids diffuse from the yolk matrix to the bulk solvent phase and the organic solvent molecules diffuse in the opposite direction. The solvent may have destroyed the structure of native phospholipid liposome and lipoproteins or have broken the affinity between the phospholipid and its associated proteins. Under the experimental conditions, assuming all the water distributed equally in the yolk-solvent system at the end of the STEP extraction (Wash No. 1), the final ethanol concentration should be about 80% (v/v). This may explain why the 95% ethanol STEP produced a phospholipid extraction result closer to the phospholipid extraction from yolk flakes by the 75% ethanol rather than the phospholipid extraction from yolk flakes by the 95% ethanol (data not shown here).

In the study by Palacios et al., “Egg-Yolk Lipid Fractionation and Lecithin Characterization,” J. Am. Oil. Chem. Soc. 82:571-578 (2005), which is hereby incorporated by reference in its entirety, a phospholipid fraction with a purity of 95% and a yield of about 12% based on fresh liquid yolk was successfully recovered. However, that method required multiple solvents (95% and 90% ethanol, hexane, and acetone) and a long sequential extraction scheme. Thus, that method needed an extensive centrifugation/filtration to effectively separate the solid and the liquid phases. Moreover, in that method, the recycling of the solvents would be an issue for the commercial adoption. In the STEP method discussed in Examples 1-4, only one solvent was needed and the phospholipid can be enriched in one step without the use of acetone.

The STEP method discussed in Examples 1-4 of the present application used one alcohol at elevated temperatures, similar to the Harsh Extraction method in Sim and Arbil patents (Canadian Patent Document No. CA 1335054 C to Sim; U.S. Pat. No. 7,566,570 B2 to Abril, which are hereby incorporated by reference in their entirety). However, the solvents and/or process conditions used in the STEP method of the present invention were different than those disclosed in the two patents. For example, in Sim's method (Canadian Patent Document No. CA 1335054 C to Sim, which is hereby incorporated by reference in its entirety), the liquid yolk to the 95% ethanol ratio was 1:4 and the treatment temperature was 60° C. Sim also used a chill treatment at 2-5° C. for 12 hours to further concentrate the phospholipid extract. Sim claimed that an egg lecithin fraction with a phospholipid purity of 89% was obtained. However, the overall phospholipid yield, which is also a critical extraction indicator, was not disclosed. Abril mixed the liquid yolk, aqueous isopropanol, and water (at a ratio of 100:60:35) at 60° C. and then centrifuged the mixture after cooling the mixture (U.S. Pat. No. 7,566,570 B2 to Abril, which is hereby incorporated by reference in its entirety). An intermediate fraction with a phospholipid purity of 70% was recovered in Abril. Abril did not present the phospholipid yield either.

In the STEP method discussed in Examples 1-4, the 95% ethanol was used with a liquid yolk to 95% ethanol ratio of 1:2 at 75° C. The more significant difference between the STEP method and the process disclosed in the Sim and Abril patents, however, relates to how the liquid yolk and solvent interacted. In the processes in Sim and Abril, the entire batch of the liquid yolk and solvent were blended at once to form a slurry-like mixture under mechanical shear force. On the other hand, the STEP method used an injection device to “spin” the liquid yolk continuously and gradually into the hot solvent to form a thin thread of texturized yolk material. This unique treatment was believed to be responsible for the results discussed in Examples 1-4. The separation of this uniformly texturized yolk material and miscella was much easier than the solvent-liquid yolk slurry produced in the conventional methods.

A simultaneous texturization and phospholipid extraction method was successfully developed and its effectiveness was demonstrated at a bench scale. Pure butanol and water-saturated butanol showed little preference for the phospholipid over the other components in the liquid yolk, but the 95% ethanol showed a significant preference for the phospholipid extraction from the liquid yolk. Under the STEP conditions used in Examples 1-4, the 95% ethanol extracted a lipid fraction with the phospholipid purity and yield of 80% and 78%, respectively. This method eliminated the need for pre-drying of the liquid yolk, the use of acetone, and centrifugation or chilling treatments that are commonly required in other egg lecithin extraction methods. Instead, a highly enriched phospholipid fraction can be recovered in one step using an aqueous ethanol. The solvent can also be directly recycled after distillation.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method for fractionating a starting material containing a protein and one or more types of lipids, said method comprising:
providing the starting material containing the protein and the lipids;
extruding the starting material into first solvent having a temperature of 20-200° C. to form a solid phase of a texturized matrix enriched with the protein and not soluble in the first solvent and a lipids-enriched fluid phase; and
collecting, separately, the solid phase of the texturized matrix enriched with the protein and the lipids-enriched fluid phase.

2. The method of claim 1, wherein the starting material is selected from the group consisting egg, egg yolk, fish roe, animal brain tissue, animal blood, diary product, microbes, oilseed, or mixtures thereof.

3. The method of claim 1, wherein said extruding is carried out such that the extruded starting material is in thread, strip, or sheet form.

4. The method of claim 1, wherein said extruding is carried out by an injection or spinning instrument.

5. The method of claim 1, wherein the formation of the solid phase of the texturized matrix enriched with the protein, during said extruding, is aided by sound energy or electromagnetic radiation.

6. The method of claim 1, wherein the first solvent is in liquid form or in gaseous form.

7. The method of claim 1, wherein said collecting the solid phase of the texturized matrix enriched with the protein is carried out by gravity precipitation, filtration, pressing, centrifugation, or combination thereof.

8. The method of claim 1 further comprising:
contacting the collected solid phase of the texturized matrix enriched with the protein with additional first solvent to extract residual lipids in the solid phase of the texturized matrix enriched with the protein.

9. The method of claim 1 further comprising:
drying, separately, the collected solid phase of the texturized matrix enriched with the protein to obtain a substantially or fully de-oiled protein, and the collected lipids-enriched fluid phase to obtain the lipids.

10. The method of claim 1 further comprising:
removing the solvent from the collected lipids-enriched fluid phase;
mixing the collected lipids-enriched fluid phase with a second solvent to separate the lipids-enriched fluid phase into a neutral lipid-enriched phase and a phospholipid-enriched phase; and
collecting, separately, the neutral lipid-enriched phase and the phospholipid-enriched phase.

11. The method of claim 10 further comprising:
drying, separately, the collected neutral lipid-enriched phase and the collected phospholipid-enriched phase.

12. The method of claim 10, wherein the second solvent is acetone.

13. A method for extracting and enriching phospholipid from a starting material containing a protein and a phospholipid, said method comprising:
providing the starting material containing the protein and the phospholipid;
extruding the starting material into a first polar solvent having a temperature of 20-120° C. to form a solid phase of a texturized matrix enriched with the protein and not soluble in the first polar solvent and a phospholipid-enriched fluid phase; and
collecting, separately, the solid phase of the texturized matrix enriched with the protein and the phospholipid-enriched fluid phase.

14. The method of claim 13, wherein said extruding is carried out such that the extruded starting material is in thread, strip, or sheet form.

15. The method of claim 13, wherein the formation of the solid phase of the texturized matrix enriched with the protein, during said extruding, is aided by sound energy or electromagnetic radiation.

16. The method of claim 13, wherein the first polar solvent is in liquid form or in gaseous form.

17. The method of claim 13, wherein the first polar solvent is 75-100% one or more alcohols containing 2-3 carbon atoms.

18. The method of claim 13 further comprising:
removing the first polar solvent from the collected phospholipid-enriched fluid phase; and
mixing the collected phospholipid-enriched fluid phase with a second solvent to separate neutral lipids from the phospholipid-rich phase; and
collecting the phospholipid-rich phase.

19. The method of claim 18 further comprising:
drying the collected phospholipid-rich phase.

20. The method of claim 18, wherein the second solvent is acetone.
